(19) United States
(12) Patent Application Publication
(10) Pub. No.: US 2012/0113019 A1
(43) Pub. Date: May 10, 2012

(54) PORTABLE E-READER AND METHOD OF USE

(76) Inventor: Michelle B. ANDERSON, Lynnwood, WA (US)

(21) Appl. No.: 12/943,597

(22) Filed: Nov. 10, 2010

(51) Int. Cl. G06F 3/041

(52) U.S. Cl. 345/173

(57) ABSTRACT

A dual screen portable e-reader with a touch pad may provide the ability for users to control the e-reader through voice commands or other advantageous user interface features. The portable e-reader may provide information to a user that is context sensitive. The e-reader may provide the text of an e-book in one language on one screen and another language on another screen.

### FIELD

The technology herein relates to e-readers, and more particularly to portable e-readers with touch screens. The technology herein also relates to portable e-reader user interface features and capabilities.

### BACKGROUND AND SUMMARY

We live in the age of literacy. Unlike olden times when only a small portion of the general population could read, a very high percentage of civilization can now read newspapers, magazines and books.

The globalization of written works has allowed works that may once have been only available in one language to now be available in many different languages. Classical works from Shakespeare may be available in Russian, or classical written works originally in Japanese work may be available in English.

Traditionally, written works have come in a physical printed paper form such as books, magazines, or newspapers. These works can vary from the Sunday edition of a local newspaper to War and Peace by Leo Tolstoy. Some say there is nothing like holding a timeless book in your hands. The book has a solid, substantial feel to it. The “user interface” associated with the book is straightforward and self-explanatory. You can flip through the pages to give you instant, random access to any particular page of interest. Looking back to a previous page is as simple as flipping a few pages in reverse. You can easily mark a page by inserting a bookmark or a ribbon, highlighting or even by folding down a corner of a page. The book can be read on the beach, in bed or in a variety of other lighting conditions.

However, it can be cumbersome for a person to carry around or store all those books, magazines, and newspapers. Further, the cost of producing and distributing these physical printed items increases overall cost and may be detrimental to the environment. These concerns may be further increased when one is considering the same book but in different languages. Indeed, in order for a person to have the same book in two separate languages, two books must purchased, carried, etc. Additionally, while books may have an easy to use intuitive interface, they are simple information devices. They only know how to present one type of content in one particular manner. Interacting with a book or its content is cumbersome at best. Thus, while printed materials have their place and serve important functions, technology may give us other possibilities.

In recent years, electronic readers, or e-readers, have begun to provide consumers with an alternative way to consume written works and other content. E-readers allow a person to review written works in electronic formats such as html, EPUB, Kindle, Plucker, plain text, pdf, etc. E-readers can take the form of software running on a personal computer, dedicated hardware devices such as the Amazon Kindle®, or provided through functionality that runs on multipurpose devices such as an Apple iPhone or iPad.

E-readers can provide increased ease of storage and portability over physical printed material. E-readers have continued to improve, and more and more written works are being made available in electronic form. These works, like their physical counter parts, may be available in many different languages. Consumers may be drawn by e-reader portability, the ease of storing numerous works in one easily accessible electronic location, instant downloading of new works, the ease of obtaining works in different languages, the potential savings, and/or the environmental friendliness associated with using e-readers and e-books. The attraction of being able to transport and access a large number of different works on a small portable or handheld device is a motivating factor.

The human-machine interface provided by an e-reader is an important aspect of its design from the standpoint of usability, salability and desirability. User interfaces are sometimes focused on visual presentation or cues to present content to a user of the e-reader. This presentation for displaying the text of a work can be accomplished through a variety of methods. For example, e-readers may use electronic ink to display the text of the content on an ordinary LCD or other screen.

A real challenge in developing an e-reader has been to come up with a user interface that is at least as good as, if not better than, the user interface provided by a physical book. Flipping pages should be as easy with an e-reader as with a physical book, magazine or newspaper while also providing enhancements such as text searching not available with physical printed works. It should also be easy to bookmark pages, and to otherwise find where you left off in your reading.

The Apple iPad® has provided a useful user interface including a touch screen for page navigation. The Nintendo DSi™ is another product that provides a useful user interface with a touch screen and presentation of content. However while the iPad®, and DSi may be a step forward, further improvements are possible and desirable. For example, one challenge has been to get consumers to spend the money to purchase an e-reader. Attempts at converting existing devices such as PCs or laptop computers into e-readers have not met with much success.

Another challenge with the user interface of e-readers is that they are very visually focused. “Consuming” the content of a book is normally a visual process. Further, user interfaces that present the content of books may become focused on visual presentation and visual cues. This is not surprising as reading is a very visual activity. However, such an overwhelming reliance on just one of the human senses can limit or potentially destroy the usability of an e-reader for certain people.

For example, a blind person may be prevented from using an e-reader because the user interface of the e-reader may entirely use a visual user interface. Further, a person may be extremely busy and may not be able to sufficiently focus his or her attention on an e-reader to make effective use of the e-reader.

It would be desirable to develop functionality that would allow a ubiquitous device, such as a handheld portable video game player, to provide enhanced user interface functionality and be used as an effective e-reader.

It will also be appreciated that there is a need in the art for improved user interfaces for portable e-readers.

Exemplary illustrative non-limiting technology herein provides:

A handheld electronic reader comprising a first display screen and a second display screen, at least one of the first and second display screens having a touch panel associated therewith; at least one memory device storing readable digital content; a processing arrangement operatively coupled to said first and second display screens and said memory device, said processing arrangement providing an interactive readable display of at least a portion of said stored digital content on said first and second display screens; wherein said processing arrangement controls said first and second display screens to display substantially the same readable content in different languages.

The e-reader may further include a microphone (or other audio input device or audio input connection—e.g., an input connection that accepts an analog or digital signal from a microphone) coupled to the processing arrangement, the microphone accepting voice commands. The e-reader may provide content including text and may further include a speaker (or other audio output device or audio output connection—e.g., an output connection that is configured to carry an analog or digital audio signal) coupled to the processing arrangement, the speaker outputting sounds corresponding to text.

The e-reader's processing arrangement may allow the user to access additional information by selecting portions of said content. The e-reader's processing arrangement may allow said user to select portions of said content by pointing on said touch panel.

In another exemplary illustrative non-limiting implementation, a handheld electronic e-reader may comprise a first display screen and a second display screen, at least one of said first and second display screens having a touch panel associated therewith; at least one memory device storing digital content; a processing arrangement operatively coupled to said first and second display screens and said memory device, said processing arrangement providing an interactive display of at least a portion of said stored digital content on said first and second display screens; wherein said processing arrangement causes said first and second display screens to display to simultaneously display verso and recto and thereby reduce the number of page change commands needed to navigate through said content.

In yet another exemplary illustrative non-limiting implementation, a handheld electronic reader may comprise a first display screen and a second display screen, the first display screen having a touch panel associated therewith; at least one memory device storing digital content; a processing arrangement operatively coupled to said first and second display screens and said memory device, said processing arrangement providing an interactive display of at least a portion of said stored digital content on said first and second display screens; wherein said processing arrangement causes said first and second display screens to display said content in a way that allows the user to orient said handheld device so that the touch panel can be placed on the left or the right and the processing arrangement adapts to the user-selected orientation to present said content so it is not upside-down relative to the user.

Additional non-limiting features and advantages include:
Allow flexible view orientation:
   a. Standard portrait for right-handed users
   b. Reverse portrait for left-handed users.
Add audio function button that would enable the unit to read aloud to the user, if audio content is available. This could be used by people that are trying to multi-task (for example: combining ingredients of a recipe, while the unit tells you what to put in). This could also allow blind people to use the unit. (Alternatively, this function might be enabled as a voice command.)
Add voice-command function button. There can be pre-defined commands that the user says to enable the unit to identify what the user is requesting. Commands such as the following may be used:
   a. Start/stop audio (if a separate button is not created)
   b. Repeat paragraph
   c. Zoom-in/zoom-out
   d. Next page/back page
   e. Next chapter/back chapter
   f. Table of contents
   g. Thesaurus
   h. Dictionary
   i. Pronounce
   j. Translate (then “French”, “Spanish”, “Japanese”, “Cantonese”, etc., whatever is available on the current book)
   k. Note pad (to make notes about the book that could be downloaded to an SD card). This feature might be especially helpful when reading cookbooks, to make shopping lists.
   l. Internet (to enable access to the internet through a web browser).
   m. Purchase (e.g., an item such as a book, song, or program is displayed/presented to a user. The user may then purchase displayed/presented item.)
Allow assignable buttons by either consumer or developers' ergonomic assessment
   a. If pre-assigned buttons: D-pad or A/Y or X/B for zoom-in/zoom-out features
Allow the same page to be displayed in an alternate language on the non-sensitive screen (instead of the previous page). This feature could be available for books with an alternate language included. Selecting the “Show Alt Language” button could bring up a list to select the alternate language, if more than one alternate language is available for the current book.
Double tapping a word with the stylus can bring up a list to allow selection of:
   a. Thesaurus (alternate words)
   b. Dictionary (meaning)
   c. Pronunciation (phonetic)
   d. Translate specific to an alternate language(s)
Voice function could be activated by:
   a. Using the touch-screen (as shown on the attached layout)
   b. Hard-coded using either the D-pad or one of the other keys (A, B, Y or X)
   c. Or, use the “L” or “R” buttons on the back edge of the unit
Allow embedded icons to provide URL links to related external content or for sale e-ware, such as books from the same genre that are also available to purchase.
Add resident calendar and note pad for the DSi XL™ (or future larger unit).

These exemplary features, aspects, and advantages may be combined in various combinations and ways to achieve yet further embodiments.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 is an exemplary illustrative non-limiting portable e-reader in communication with an external e-book service;

FIG. 2A is an exemplary illustrative non-limiting view of the FIG. 1 portable e-reader;

FIG. 2B is an exemplary illustrative non-limiting view of the portable e-reader of FIG. 2A in a closed position;

FIG. 3A is an exemplary illustrative non-limiting view of an example non-limiting user interface for a portable e-reader in use;

FIG. 3B is another exemplary illustrative non-limiting view of a user interface for a portable e-reader in use;

FIG. 3C is a further exemplary illustrative non-limiting view of a user interface for a portable e-reader using an alternate orientation;

FIG. 3D is an exemplary illustrative non-limiting view of a user interface for a portable e-reader displaying the same content in English and Spanish;

FIG. 3E is an exemplary illustrative non-limiting view of a user interface for a portable e-reader displaying the same content in Japanese and Spanish;

FIG. 4 is a flowchart of an exemplary illustrative non-limiting embodiment of voice command options for a portable e-reader;

FIG. 5 is a flowchart of an exemplary illustrative non-limiting embodiment of double tap options for a portable e-reader;

FIG. 6 is a flowchart of an exemplary illustrative non-limiting usage of a portable e-reader;

FIG. 7 is an exemplary illustrative non-limiting block diagram of the internal structure of a portable e-reader;

FIG. 8A is an exemplary illustrative non-limiting block diagram showing the internal structure of a non-transitory e-book storage medium storing example e-books; and

FIG. 8B is an exemplary illustrative non-limiting block diagram showing the internal structure of a non-transitory e-book storage medium storing an e-book in different languages.

### DETAILED DESCRIPTION

The technology herein can be used with dedicated or non-dedicated e-readers or e-reader software used on general or other computing devices (e.g., software applications that run on personal computers, cellular telephones, gaming devices or other electronic display devices).

One exemplary illustrative non-limiting implementation of an e-reader 200 includes a portable gaming device sold by Nintendo such as is disclosed in U.S. Publication Number 2009/0305783, the contents of which are hereby incorporated by reference. Such a portable device may include a Nintendo DSi XL™, XL™ or a Nintendo DSi™. While certain exemplary illustrative non-limiting implementations are described below with reference to a Nintendo DSi XL™ or Nintendo DSi™, the technology described herein may be applied to other portable and non-portable gaming or other devices including smart phones, tablet computers, flexible computers, etc.

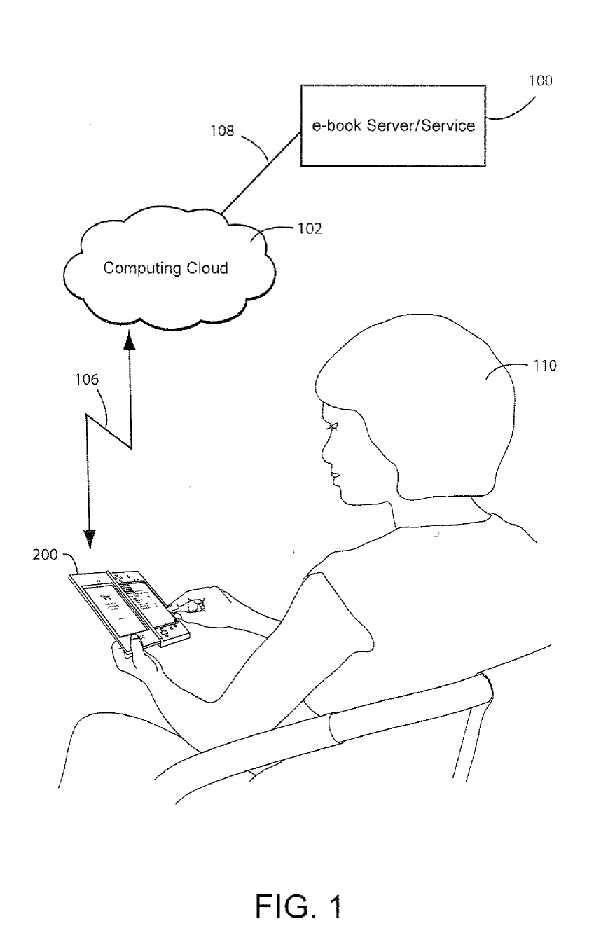

FIG. 1 shows an exemplary illustrative non-limiting e-reader 200 in communication with an external e-content service. User 110 is using e-reader 200 to read electronically delivered content. E-reader 200 is in communication with computing cloud 102 over wireless or wired communication link 106. The communication link 106 may use any of the various wireless or wired protocols to transmit information between e-reader 200 and computing cloud 102. Wireless protocols may include, for example, Bluetooth, 802.11x protocols, Wi-MAX, GSM, Bluetooth, etc.

Computing cloud 102 may be in communication with e-book server/service 100 over data link 108. E-book server/service 100 may provide e-books, electronic content and other information to e-reader 200 through computing cloud 102 and over links 106, 108. It will be appreciated that e-book server 100 may include many different servers operating to provide some or all of an e-book service. Computing cloud 102 may provide additional services and functionality for e-reader 200. For example, computing cloud 102 and/or e-book server 100 may provide authentication and other application services for e-reader 200. For example, computing cloud 102 and/or e-book server 100 may associate e-reader 200 with an account owned by or associated with user 110. Once authenticated, e-reader 200 may then access content and services specifically available to user 110. Computing cloud 102 and/or e-book server 100 may alternatively, or in addition to, provide new applications that are sent over wireless communication link 106 to e-reader 200. E-book server 100 may be a general content server that stores and provides various types of electronic media beyond books, such as, for example, textbooks, newspapers, movies, audio files, video games, streaming video or audio, etc. Thus, the e-reader 200 can work in a connected, unconnected and/or intermittently-connected mode. It can be used to present all sorts of content including but not limited to written content, printed content, text content, sound content, image content, web content, mixed media, animation, etc. to the user. The user can use the interactive user interface that the e-reader 200 provides (e.g., to review the content, navigate through the content, and/or control what is presented and how it is presented).

The exemplary illustrative non-limiting e-reader may provide any or all of the following user interface features alone or in combination:
Allow flexible view orientation, such as, for example a “standard” portrait for right-handed users and “reverse” portrait for left-handed users.
Audio function button that enables the e-reader to read aloud to the user, if audio content is available. This could be used by people that are trying to multi-task (for example: combining ingredients, while the unit tells you what to put in) and could also allow blind people to use the unit. (Alternatively, this function might be enabled to a voice command.)
Voice-command function button can use pre-defined commands that the user says to enable the unit to identify what the user is requesting. Commands such as: Start/stop audio (if a separate button is not created), Repeat paragraph, Zoom-in/zoom-out, Next page/back page, Next chapter/back chapter, Table of contents, Thesaurus, Dictionary, Pronounce, Translate (then “French”, “Spanish”, “Japanese”, “Cantonese”, etc., whatever is available on the current book), Note pad (to make notes about the book that could be downloaded to an SD card). This feature might be especially helpful when reading cookbooks, to make shopping lists, etc.
Allow assignable buttons by either consumer or developers' ergonomic assessment; If pre-assigned buttons: D-pad or NY or X/B for zoom-in/zoom-out features
Allow the same page to be displayed in an alternate language on a non-touch-sensitive or other second screen (instead of the previous page). This feature could be available for books with an alternate language included. Selecting the “Show Alt Language” button would bring up a list to select the alternate language, if more than one alternate language is available for the current book.
Double tapping a word with a finger or stylus can bring up a list to allow selection of: Thesaurus (alternate words), Dictionary (meaning), Pronunciation (phonetic), and Translate specific to an alternate language(s).
Voice function can be activated by using the touch-screen (as shown on the attached layout) or, hard-coded using either the D-pad or one of the other keys (A, B, Y or X) or, use the “L” or “R” buttons on the back edge of the unit.
Allow embedded icons to provide URL links to related external content or for sale e-ware, such as books from the same genre that are also available to purchase.
Add resident calendar and note pad for the DSi XL™ (or future larger unit).

### Exemplary E-Reader

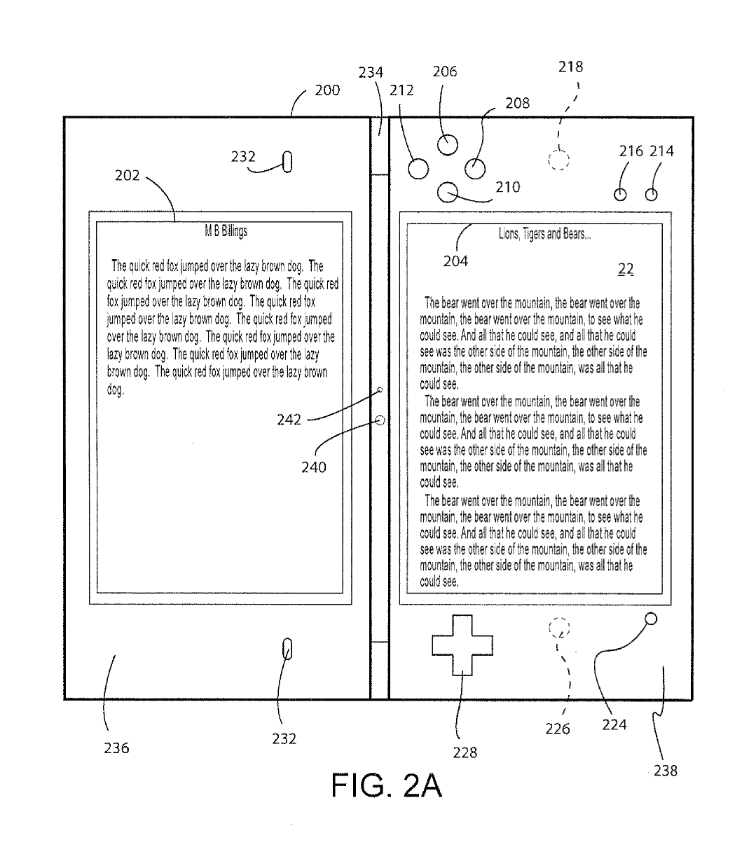

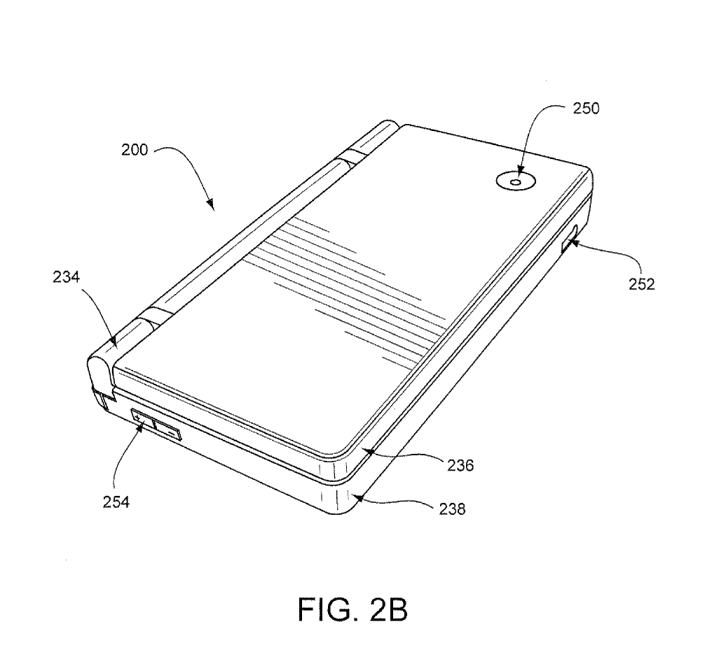

FIG. 2A is an exemplary illustrative non-limiting more detailed view of a portable e-reader 200. Portable e-reader 200 is shown in an open position in FIG. 2A and in a closed position in FIG. 2B. E-reader 200 includes a first housing 236 connected through hinge 234 to second housing 238. First housing 236 may include a first liquid crystal display (hereinafter, referred to as “LCD”) 202. Similarly, second housing 238 may also include a second LCD 204. Both housings may be slightly recessed from the main body of e-reader 200. Hinge 234 facilitates the closure of e-reader 200 such that the first housing and the second housing are on top of each other in a manner similar to a closed book. The recessed nature of housings 236 and 238 may facilitate a flushed closing around the edges of the main body of e-reader 200.

Second LCD 204 may further include touch panel 22. Touch panel 22 may be constructed to sense pointing and touching by, for example, any resistance film system, an optical or infrared system, or any capacitance system. When touch panel 22 is pressed by an object, such as, for example, a finger or stylus, the coordinate position of the press is recorded by e-reader 200 and is used as input for operation of e-reader 200 (described in more detail below). Alternatively, or in addition, the first LCD 202 may include a touch panel.

Various buttons may be provided to facilitate user input for e-reader 200. As explained below the functionality associated with these buttons may be hardcoded or may be configurable by a user. Y button 210, X button 212, A button 206, and B button 208 may be provided in the upper left part of second housing 238. These buttons may provide a user with zoom capability on a given e-book. For example, hitting A button 206 may zoom in the view on an e-book and thus make the displayed text bigger and easier to read.

An additional audio button 218 may provide functionality to activate and deactivate audio of e-reader 200. Start button 216 and select button 218 may be provided in the upper right hand portion of second housing 238. Pushing both start and select buttons 216, 218 at the same time may cause the e-reader software to exit. In the lower left part of housing 238, D-Pad (directional pad) 228 may be provided to facilitate user input for the manipulation of either or both of the LCD screens 202 and 204. For example, D-Pad 228 may provide directional scrolling over the displayed text. Thus, pressing the left arrow on D-Pad 228 would scroll the displayed text to the left, pressing the right arrow would scroll to the right, etc.

In the middle lower part of housing 238 a voice command button 226 may be provided to allow a user to control voice recognition functionality of e-reader 200. In the lower right corner of housing 238 power button 224 may be provided to control the on/off status of e-reader 200. Any or all of these controls could be implemented by touch sensitive buttons on touch screen 22.

In housing 236, speaker holes 232 may be provided to give audio output functionality to e-reader 200. Microphone hole 242 may be provided in the body of hinge 234. User Facing Camera 240 may be a camera that is similar to Camera 250. Further, in certain illustrative embodiments User Facing Camera 240 and Camera 250 may be selectively switched between.

In an alternative exemplary illustrative embodiment, “L” and “R” buttons may be provided along the underside of hinge 234. As with the above buttons and switches, these buttons may also be configurable.

FIG. 2B is an exemplary illustrative non-limiting view of the portable e-reader of FIG. 2A in a closed position. In the closed position, first housing 236 is substantially congruent with second housing 238. Hinge 234 facilitates the opening and closing of portable e-reader 200 (e.g., portable e-reader may be opened and viewed as in FIG. 2A or closed as in FIG. 2B). It will be appreciated that in a closed position, the “footprint” that portable e-reader 200 takes up is substantially half of the e-reader in an open position. Thus, a user may close portable e-reader 200 and easily place portable e-reader 200 into their pocket, purse, etc.

For example, a user may wish to read a book on portable e-reader 200. The user may “open” the book by opening portable e-reader 200. When the user is done reading the book on portable e-reader 200, the user may “close” the book by simply closing portable e-reader 200. In the closed position the user may then slip portable e-reader into a pocket, place on a nightstand, put into a bookshelf, etc.

First housing 234 may include a camera 250 on an outer major surface of first housing 234. Connector 252 may provide a connection for a headphone, microphone, headset, or the like. In certain exemplary illustrative non-limiting embodiments, connecting a headset, may cause sound not to play through speakers 232 and/or microphone 242 to become disabled (e.g., so as not to accept audio input through microphone 242). Instead audio input and/or output may be provided through connector 252 to/from an accessory (not shown) plugged into connector 252. In other embodiments, plugging in an accessory into connector 252 may or may not disable audio input and/or output through speakers 232 and/or microphone 242.

Volume adjustment switches 254 may provided to facilitate volume control for portable e-reader 200. Volume control may affect the volume of sound output through speakers 232 and/or volume of sound output through connector 252.

### Exemplary E-Reader Operation

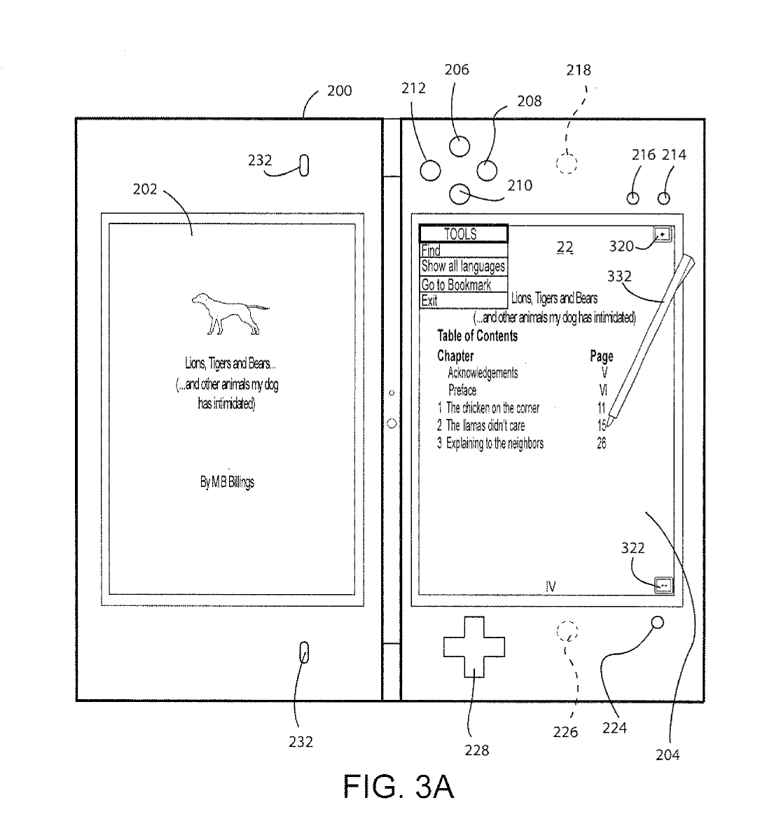

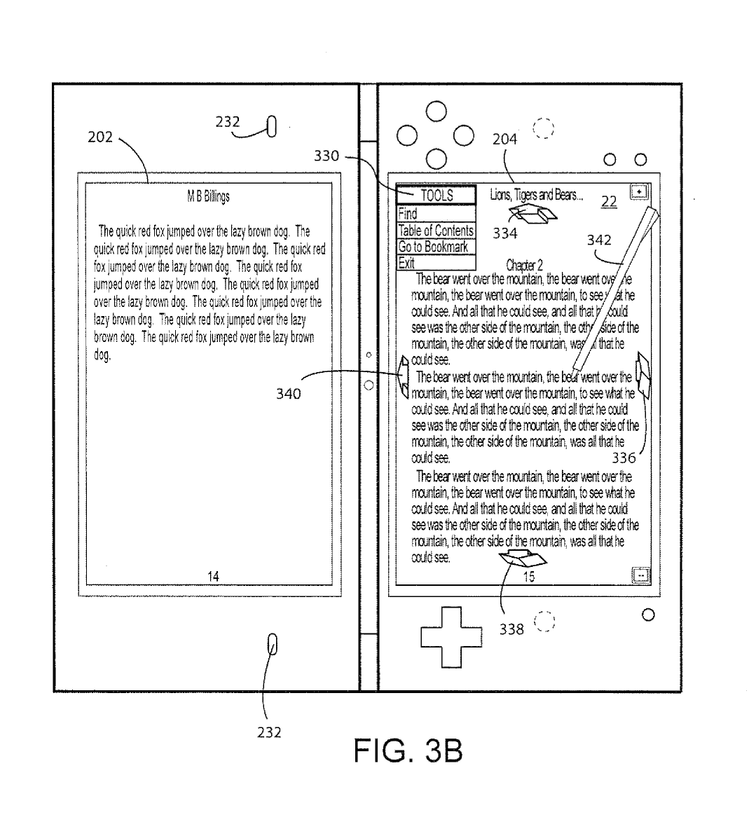

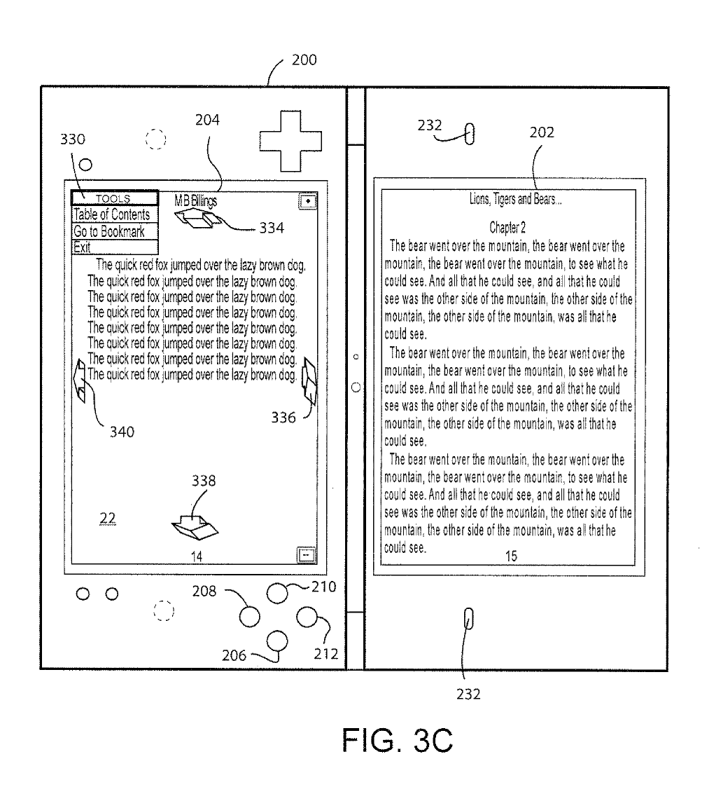

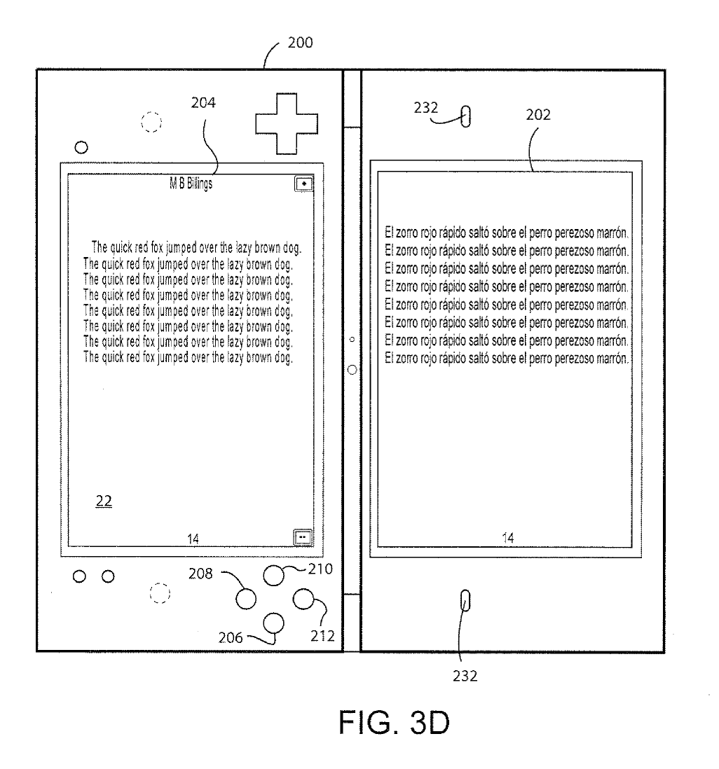

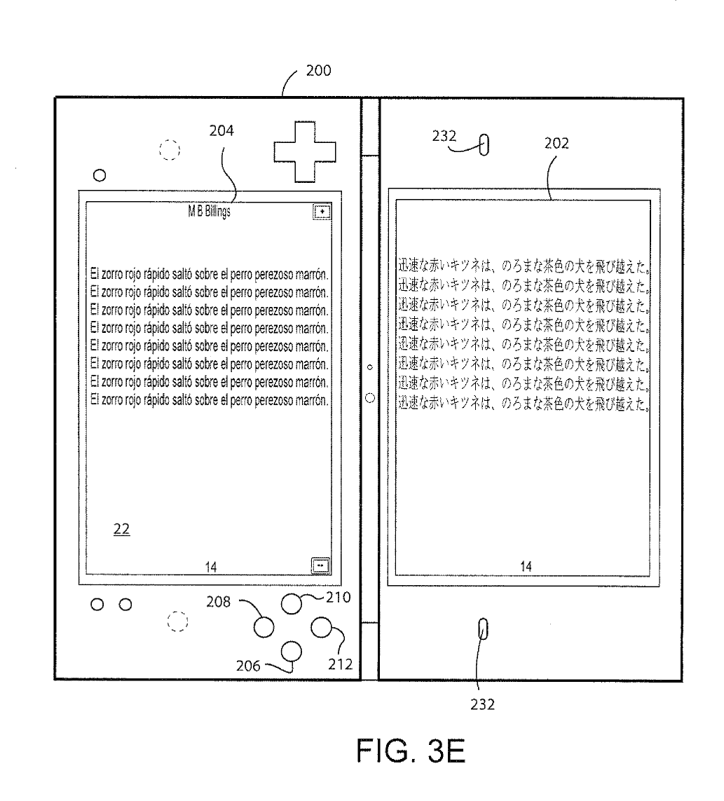

FIG. 3A is an exemplary illustrative non-limiting view of a user interface for a portable e-reader in use. The first LCD 202 may display the title of an e-book, such as, for example, “Lions, Tigers and Bears . . . ( . . . and other animals my dog has intimidated)” by “M B Billings.” The second LCD 204 may display the table of contents of the e-book, such as the table of contents of “Lions, Tigers and Bears . . . ” As will be discussed below, a user may configure e-reader 200 to display the contents of an e-book in various ways.

In one such configuration, page X of an e-book is displayed on the first LCD 202 (where X is the page number of the e-book that is displayed). Correspondingly, on the second LCD 204 page X+1 may be displayed.

The second LCD panel 204 may be associated with touch panel 22. When in operation, e-reader 200 may display on touch panel 22 and display 204 various user interface features that a user may use.

Displayed buttons 320 (+) and 322 (−) may provide navigational functionality to an e-book. These buttons may be provided on the second LCD 204 and may fade out if touch panel 22 is not activated in the display area of buttons 320 or 322. Alternatively, the buttons may shrink in size, become more transparent, or remain in a static form.

When button 320 (+) is pressed (activated, etc.), the book may advance one page. Thus, after pressing button 320, first LCD 202 may display page X+1, and second LCD may display page X+2. In an alternative configuration, when button 320 is pressed, the book may “flip” the page as is done similarly with a physical book. Thus, in this configuration when button 320 is pressed, first LCD 202 will display page X+2 and second LCD 204 will display page x+3. In this manner, users may experience a feeling similar to turning a page in a physical book.

Button 322 (−) may operate in a similar manner by decrementing the displayed pages of the e-book (e.g., displaying page X−1).

The user interface provided on e-reader 200 may also include a tool or options menu. In FIG. 3A, tools menu 330 is displayed with the following menu items: 1) Find; 2) Table of Contents; 3) Go to Bookmark; 4) Exit. “Find” functionality in tools menu 330 may bring up an additional screen that facilitates finding some information or location within a given e-book. This may be accomplished, for example, through a new screen or presenting the user with an overlay. The “Go to Bookmark” menu item may provide functionality for quickly navigating to bookmarked page or section of an e-book. This may operate similar to placing a bookmark into a physical book.

In certain exemplary illustrative non-limiting embodiments, closing the portable e-reader 200 may automatically save a bookmark for the position that a user was last at in a book when the portable e-reader was open. When the user subsequently opens the portable e-reader 200, the book may be automatically loaded and the last page viewed by the user may be displayed. Thus, portable e-reader 200 may mimic the process of bookmarking a place in a physical book.

Tools menu 330 may also include an option called “Show Alt Language.” In selecting this feature, a user may be presented with a further menu for the selection of an alternate language to display the text of the e-book in. Thus, a user may select, for example, “French”, from a list of languages that include: “Japanese,” “Spanish,” “Cantonese,” etc. By enabling the “Show Alt Language” functionality and selecting “French,” the text of the displayed e-book may be displayed on the corresponding window. Additional menu options may be added or substituted for those menu items in tool menu 330.

When tool menu 330 is not in use, the menu may collapse such that only the “Tools” icon is displayed. Tools menu 330 may then reactivate to expand and show the menu items when the “Tool” icon is pressed by a user.

The user interface on e-reader 200 may also provide additional functionality through touch panel 22. For example, the chapter listings in FIG. 3A may provide a convenient way for a user to jump directly to a selected chapter. Thus, in FIG. 3A the pressure on touch panel 22 provided by stylus 332 will trigger the e-book to jump to chapter 2, “The llamas didn't care,” on page 15. This functionality may be context sensitive based on what type of page is being displayed to the user. For example, if the table of contents page is displayed, pressing the touch panel may use the above page jumping functionality. Other context sensitive features linked to touch panel 22 are described below.

FIG. 3B is another exemplary illustrative non-limiting view of a user interface for a portable e-reader in use. The beginning of chapter 2, starting on page 15 of “Lions, Tigers and Bears . . . ” is displayed. Tools menu 330 is displayed in the upper left corner of the second LCD 204. The menu items available in tools menu 330 when a content page is displayed may be different from the menu items displayed when another section of the e-book is displayed (e.g., the table of contents section). For example, the “Table of Contents” menu item as shown in FIG. 3B may be included where is was previously not included in FIG. 3A. The tools menu 330 may thus be context-sensitive.

In addition to the above menu items, a further menu item called “add note” may be provided. This menu item may provide functionality to a user for storing a note about a certain page in a book. For example, if a student is reading a textbook and wishes to remember something relating to a particular section, the student may activate this functionality and add a note to the page in question.

Scroll arrows 334, 336, 338, and 340 may be displayed on the second LCD 204. These arrows may provide functionality to a user of e-reader 200 for scrolling up, right, down, and left respectively. The arrows may be displayed along side the text of the loaded e-book as shown in FIG. 3B. In this configuration the maximum viewing area for text may be slightly decreased (e.g., the arrows take up the outer edge of the display). Further, in this configuration the size of the text may be correspondingly decreased or the size of the text may remain the same with less characters being displayed in the reduced viewing area. Alternatively, the arrows may be superimposed over the displayed text (e.g., as semi-translucent) to allow for the maximum viewing area of the text on the second LCD 204. In this configuration, the arrows may then fade out and become invisible if not in use.

The way words are presented by e-reader 200 may be configurable by the user or be configured by the e-reader 200. For example, a user may wish to configure the text such that only the top and bottom arrows (334 and 338 respectively) are used. Alternatively, the pages of an e-book may be divided by e-reader 200 such that the second LCD displays as much text as possible without the use of arrows 334, 336, 338, and 340. In this configuration, buttons 320 and 322 may provide navigation functionality for the content of the displayed e-book (e.g., instead of displaying the next “page,” of the e-book, the next section of text would be displayed).

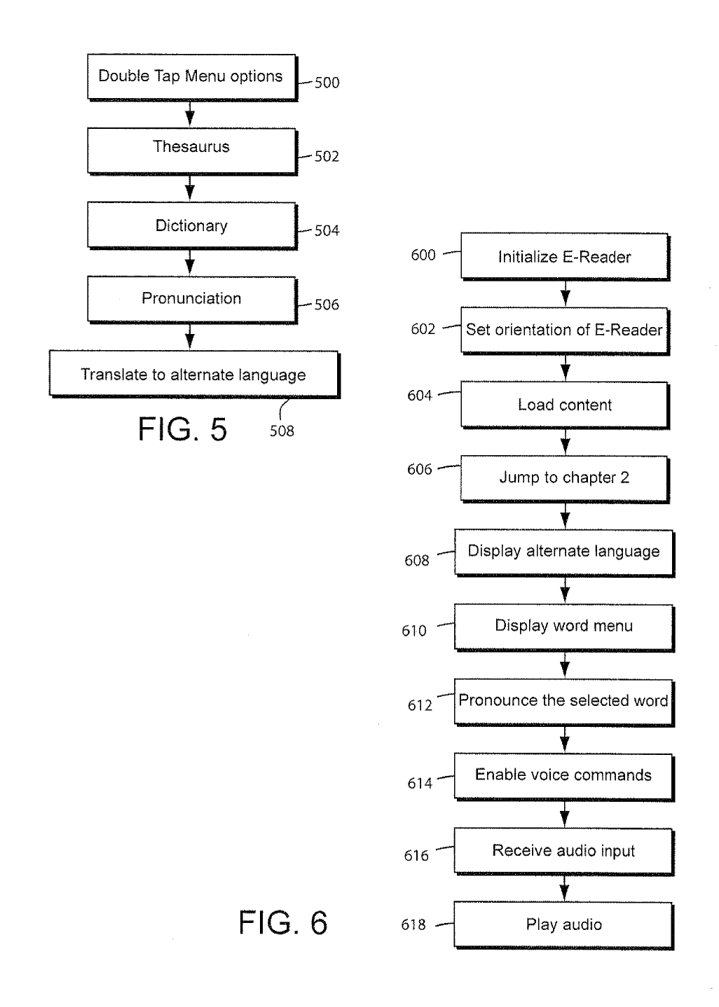

Referring again to FIG. 3B, tapping the word “bear” with stylus 342 may result in the tapped word to be audibly outputted by e-reader 200. In other words, when a user taps a word e-reader 200 will pronounce the word for the user. Alternatively, tapping a word may bring up a menu with a list of menu items. These menu items may include the items shown in FIG. 5. The selection of one of the items by a user would result in e-reader 200 carrying out the selected task. In a further alternative illustrative embodiment, a single tap of a stylus (or other object) may result in default functionality, whereas double tapping on a word may bring up the menu and the list of items.

In another exemplary illustrative embodiment, the displayed e-book may have embedded icons or links. The links may be associated with the page a user is currently reading or may be associated with any other feature of the currently loaded content or application. These links may provide additional commentary on a given topic. For example, a user reading chapter 2 (“The llamas didn't care”) of “Lions, Tigers, and Bears . . . and other animals my dog has intimidated,” may be provided with a link to information about the characteristics of llamas. Further, a user reading chapter 1 (“The chicken on the corner”) may instead be presented with a link to information on chickens.

The links may also provide opportunities for users to purchase items. For example, the user may be presented with an option to purchase or download other books from M B Billings or other books that are in the same genre.

FIG. 3C is a further exemplary illustrative non-limiting view of a user interface for a portable e-reader using an alternate orientation. In this configuration e-reader 200 is turned 180 degrees, putting the second LCD on the left and the first LCD on the right. Further, touch panel 22 is also on the left. This configuration may provide increased usability for left handed users. This reverse configuration may be activated or controlled from the system settings in e-reader 200. Alternatively, the configuration may be modified through a menu item in tools menu 330 or automatically by sensing the output of an accelerometer or other gravity sensor.

The text displayed in the second LCD 204 in FIG. 3C may be the text that was displayed in the second LCD of FIG. 3B. Alternatively, the text displayed in the second LCD may be the text displayed in the first LCD of FIG. 3B. In addition to textual display changes, the functionality provided in Y button 210, X button 212, A button 206, and B button 208 may now be provided by D-Pad 228. Correspondingly, the functionality provided by D-pad 228 may now be provided by Y button 210, X button 212, A button 206, and B button 208.

For example, in one illustrative non-limiting embodiment, D-pad 228 may provide directional scrolling over the displayed text in a “standard” configuration. However, in a “reverse” configuration the above Y, X, A, and B buttons may provide such functionality (e.g., B button 208 may scroll the text to the user's left). Thus, in certain illustrative non-limiting embodiments the buttons, in addition to screen functionality, may also be changed to correspond to new configurations. It will be appreciated that some buttons may not change their functionality (e.g., the power button) while other buttons do change their functionality based on the type of orientation selection.

Additional orientations may also be used in alternative embodiments. For example, in one exemplary illustrative embodiment e-reader 200 may be oriented such that the user interface may be configured to have the first LCD 202 “on top” of the second LCD 204. In this embodiment the two LCD screens may be treated as one continuous display screen. Alternatively, the first LCD 202 may display the text of the previous page or, as described above, may display the text of the second LCD 204 in an alternate language.

As noted above, portable e-reader 200 may have functionality to display different languages. FIG. 3D is an exemplary illustrative non-limiting view of a user interface for a portable e-reader displaying the same content in English and Spanish. In the alternate orientation describe above, second LCD screen 204 may display page 14 with the “The quick fed fox jumped over the lazy brown dog,” several times. In this non-limiting view, a Spanish version of the above text is displayed in the first LCD screen 202 instead of displaying the next page in English. It will be appreciated that the conversion of text between languages may result in a different quantity of content being displayed on either of the two display screens (e.g., because certain languages may take more or less room to display the same content).

FIG. 3E is an exemplary illustrative non-limiting view of a user interface for a portable e-reader displaying the same content in Japanese and Spanish. In this illustrative non-limiting view second LCD screen 204 may display page 14 of M B Billings book in Spanish and on the first LCD screen 202 may also display page 14 of M B Billings in Japanese. Accordingly, in certain non-limiting embodiments a user may selectively determine what language is to be displayed on a given screen for a particular book or piece of content. The portable e-reader may include functionality that automatically switches between a side-by-side view of content when two languages are selected and a verso and recto view when both screens have the same language selected. As such, a user may enjoy an e-book in more than one language.

In additional embodiments the audio output feature may be combined with the above described alternative language feature. For example, a user may use the alternate language feature to display the text in Spanish and the audio output may be in Spanish. Alternatively, the text may be in English and the audio output may be in Spanish. The audio output may correspond to the text displayed in the first or second LCDs. It will be appreciated that such functionality may facilitate learning a new language. Furthermore the audio input may be configured to accept voice input in a given language for voice command operation.

### Example Non-Limiting E-Reader Software

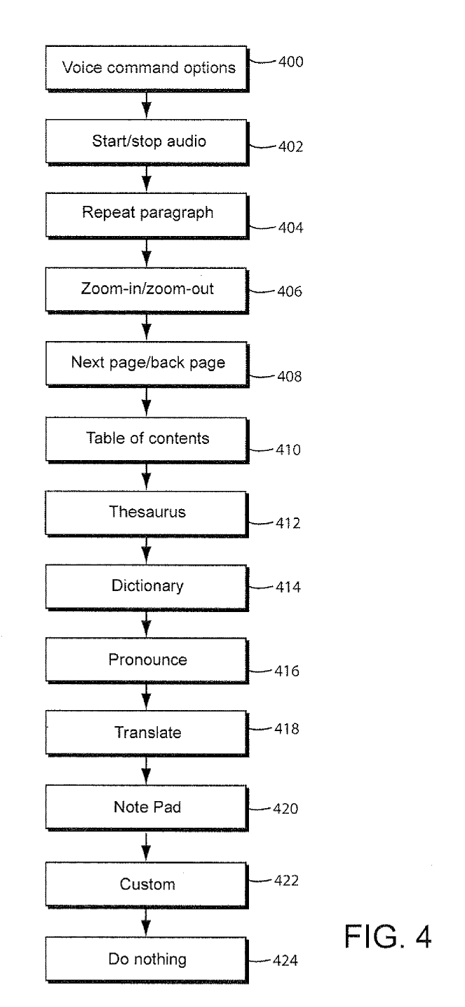

FIG. 4 is a flowchart of an exemplary illustrative non-limiting voice command options for portable e-reader 200. As discussed above, button 226 may provide a switch or button for activating and deactivating the voice command functionality of e-reader 200. When voice commands are turned off, the speech of a user may not trigger voice command options 400. When button 226 is turned on, voice commands options 400 may be activated. Some of the options that may be available for voice commands include, start and stop audio 402, repeat paragraph 404, zoom-in and zoom-out 406, next page and previous page 408, table of contents 410, thesaurus 412, dictionary 414, pronounce 416, translate 418, note pad 420, custom command 422, and do nothing 424. Each of the above options may be associated with an audio reference.

The audio references may be generated from speech recognition techniques or may be created by the user. If the user creates the audio references, the user may then associate the voice commands with his or her voice. This operation may be accomplished by presenting the user with a configuration menu for various standard voice commands with the option for creating custom commands. Thus a user may be able to tailor the voice commands to his or her specific preferences. For example, for the repeat paragraph command a user may record “repeat” as the reference voice command or may record “repeat paragraph” as the reference voice command. Further a user may create custom voice commands. For example, a custom command called “advance 10 pages” may result in an e-book being advanced 10 pages.

Note pad 420 may provide a two step process of triggering a note pad. First, a command may activate the note pad. Second, the user may provide input that is automatically transcribed to the opened note pad. The note pad functionality may also be activated through other means, for example, the tools menu.

As an example of the note pad functionality, a user may download a recipe for a particular meal. However, while following the given recipe the user may decide to deviate slightly from the recipe. The user may then activate the note pad functionality and record the modification to the recipe. Alternatively, the user may directly mark up the displayed recipe with his or her changes. In another example a user may create a shopping list with the note pad functionality.

When voice command options 400 are activated and microphone 66 receives input, the above options are compared to the received input and action is taken based on the received input. Further, as is known, voice recognition software may allow for learning a user's voice in order to improve functionality over time. Thus in operation, e-reader 200 proceeds checking each one of options shown in FIG. 4. If the received input substantially matches the reference command, the selected command is executed. This way a user can enjoy hands-free usage of the e-reader 200.

FIG. 5 is a flowchart of an exemplary illustrative non-limiting double tap options for a portable e-reader. As discussed above, based on system configuration such a menu may be activated using a single or double tap onto touch panel 22. For example, double tapping the word “bear” in FIG. 3B may result in a menu being displayed that includes a thesaurus 502 option, a dictionary 504 option, a pronunciation 506 option, and a translate to alternate language 508 option. Selecting the “translate to alternate language” 508 option may provide a further menu for translating the selected word into a given language. Thus, translating the word “bear” to Spanish may provide an overlay indicating the translated word.

FIG. 6 is a flowchart of an exemplary illustrative non-limiting usage of a portable e-reader 200. In step 600 the e-reader 200 is initialized. Then in step 602 a user sets the orientation of e-reader 200. Next, the user selects an e-book to view and in step 604 the content of the e-book is loaded by e-reader 200. Once the content is loaded, the user is presented with the table of contents of the loaded e-book. The user decides to jump immediately to chapter 2. In step 606 e-reader 200 jumps directly to the first page of chapter 2 in the selected e-book. Next, the user chooses to display the e-book in an alternative language. For example, the user may select “Japanese” as the alternative language. In response to the user's selection, in step 608, e-reader 200 displays the text of the e-book in Japanese in the first LCD 202. Next, a user taps touch panel 22 on a word. In response to the user's action, in step 610, e-reader 200 displays the single word menu. Next the user decides to have e-reader 200 pronounce the word, and in step 612 e-reader 200 pronounces the word. Delighted with this functionality, the user then proceeds to turn on the voice commands functionality by activating button 226. E-reader 200 responds to the activated button and, in step 614, activates voice command options 400 for the language currently being displayed and/or for a default or selected language. The user then proceeds to tell e-reader 200 to “start audio.” E-reader 200 receives the command in step 616 and determines that the proper command is 402. Subsequently, in step 618 e-reader 200 starts outputting the audio of the text displayed on the second LCD 204. At this point the user sits back to relax as e-reader 200 reads the words of the selected e-book in the displayed language.

### Example E-Reader Architecture

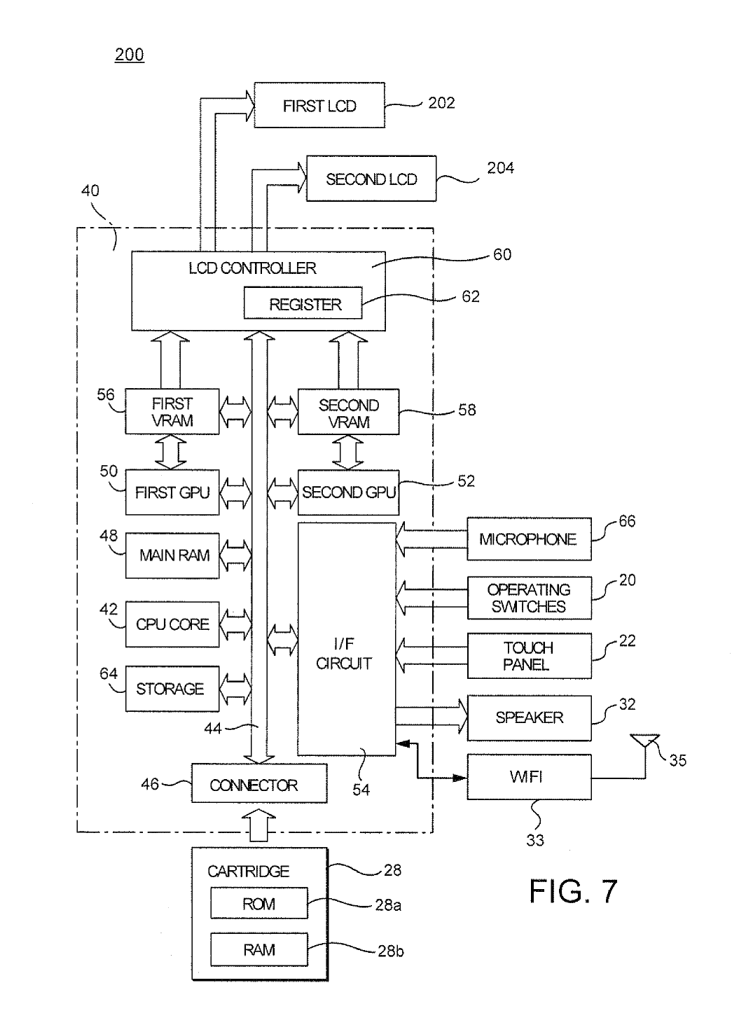

An exemplary illustrative non-limiting block diagram of the internal structure of a portable e-reader is shown in FIG. 7, which may be based on or comprise a conventional handheld computing device such as a Nintendo DS™ or DSi™ video game system. Electronic circuit board 40 may be disposed in the second housing 238. Electronic circuit board 40 may have a CPU core 42 mounted thereon. CPU core 42 may be connected to bus 44. Bus 44 facilitates the transfer of data between the connected components.

Connector 46 connects to bus 44. Cartridge 28 may be detachably connectable to connector 46. Cartridge 28 may be a memory medium for the storage of data that may be accessible to e-reader 200 when cartridge 28 is mated to connector 46. Cartridge 28 may include a nonvolatile semiconductor memory such as a ROM or a flash memory. Other medium types for storing data may also be used such as, for example, a CD-ROM, a DVD, or a similar optical memory medium.

Cartridge 28 might comprise a SD card or similar non-transitory memory medium, or may be split into discrete memory types. First, cartridge 28 may have “read only memory” or ROM 28a for storing application or static data. Such data may include, for example, an e-book or other type of program that is to be displayed on e-reader 200. Cartridge 28 may also optionally include RAM 28b for rewritably storing backup or application data thereon. Such writable data may include, for example, options specific to the presentation of the particular book stored in ROM 28a, notes that a user may create and associate with a given book (e.g., notes that a student may create when reading a textbook), or other types of information a user or e-reader 200 may create. Other implementations can use entirely embedded memory.

The e-book reading application stored in ROM 28a in cartridge 28 or in internal flash memory is loaded into main RAM 48 and executed by CPU core 42. Temporary data and data for generating an image which are obtained by the CPU core 42 through execution of the application are stored in the main RAM 48.

As described above, ROM 28a stores an application, which is a group of instructions and a group of data in the format executable by the computer of e-reader 200, especially by CPU core 42. The application is read into and executed by main RAM 48 when necessary. In this embodiment, the application and the like are recorded in the cartridge 28, but the application and the like may be supplied by another medium (e.g., alternative storage) or via a communication network (e.g., a downloadable program).

Internal storage 64 may also be included in e-reader 200. Similar to cartridge 28, internal storage 64 may store data. This data may include application software (e.g., programs) or application data (e.g., content). Internal storage 64 may be flash memory or other similar nonvolatile memory for data storage. Data may be read from and written to storage 64 as needed by e-reader 200.

A first GPU 50 is connected to a first video RAM (hereinafter, referred to the “VRAM”) 56, and the second GPU 52 is connected to a second VRAM 58. In accordance with an instruction from CPU core 42, the first GPU 50 renders image data based on data for generating an image stored in main RAM 48. The rendered image data from the first GPU 50 may be stored in the first VRAM 56. In accordance with an instruction from CPU core 42, the second GPU 52 renders image data based on data for generating an image stored in main RAM 48. The rendered image data from the second GPU 52 may be stored in the second VRAM 58.

The first VRAM 56 and the second VRAM 58 are connected to LCD controller 60. LCD controller 60 includes register 62, and register 62 consists of, for example, one bit, and stores a value of “0” or “1” (data value) according to an instruction of CPU core 42. LCD controller 60 outputs the screen data rendered in the first VRAM 56 to the first LCD 202, and outputs the screen data rendered in the second VRAM 58 to the second LCD 204 in a case that the data value of the register 62 is “0”. Furthermore, LCD controller 60 outputs the screen data rendered in the first VRAM 56 to the second LCD 204, and outputs the screen data rendered in the second VRAM 58 to the first LCD 202 in a case that the data value of register 62 is “1”. It is noted that in the interests of simplicity, “0” is constantly stored in register 62 in this exemplary illustrative embodiment.

An I/F circuit is a circuit for exchanging data between external input/output devices. In FIG. 2B I/F circuit 54 is connected to touch panel 22, operating switches 20 (e.g., that interface with buttons on the e-reader 200, such as, for example, Button “B” or optional button 226), speaker 32, Wi-Fi adapter 33, and microphone 66. Touch panel 22 may be located in the same area as the second LCD 204 shown in FIG. 2A. Operating switches 20 may communicate with the buttons and switches shown in FIG. 2A. Speaker 32 may be located at a position just inside speaker holes 232 described above in FIG. 2A. Microphone 66 may be located in a position substantially disposed within or beneath microphone hole 242.

Wi-Fi adapter 33 may be included to enable e-reader 200 to communicate with external network access point 35 and thus facilitate network enabled features on e-reader 200. Wi-Fi adapter 33 may be a wireless adapter that supports 802.11b, 802.11g, or 802.11n. Alternatively, WiFi adapter 33 may instead by a wired adapter that would use, for example, a wired Ethernet connection through a RJ 45 or other port.

Touch panel 22 may have a coordinate system corresponding to the coordinate system of the second VRAM 58 and outputs coordinate position data corresponding to the position which is input (e.g., indicated) by a stylus or the like. The resolution of the touch panel may correspond to the resolution of the second LCD 204. For example, the resolution of the second LCD 204 may be 256 dots by 192 dots, and then the precision of touch panel 22 would be 256 dots by 192 dots. Alternatively, the precision of the touch panel may be higher or lower than the precision of the second LCD. Further, another touch panel may be added to e-reader 200 that corresponds to the first LCD 202. Alternatively, touch panel 22 may correspond to the first LCD 202.

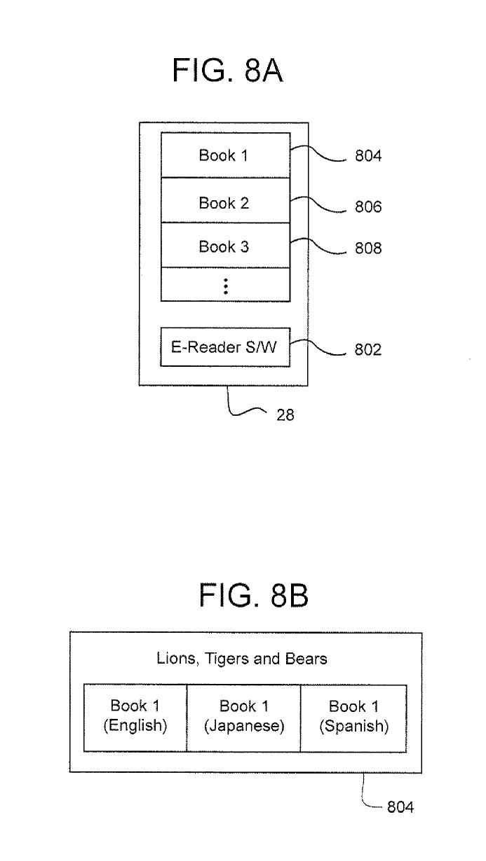

FIG. 8A is an exemplary illustrative non-limiting block diagram showing the internal structure of a non-transitory e-book storage medium storing example e-books. As discussed above, memory cartridge 28 may be various types of non-volatile memory storage devices (e.g., flash memory, CD-ROM, etc). Contained in memory cartridge 28 may be e-reader software 802. Alternatively, or in addition, e-reader software may be stored internally to an e-reader.

Also stored in memory cartridge 28 may be a plurality of books: book 1 804; book 2 806; and book 3 808; etc. Thus, a user may be able to carry around a large quantity of books within a small memory device. Alternatively, there may only be one book located on a given memory cartridge. Further, memory cartridges may include books from one particular, author, series, genre, etc.

FIG. 8B is an exemplary illustrative non-limiting block diagram showing the internal structure of a non-transitory storage device storing an e-book in different languages. As discussed above, certain exemplary portable e-readers may allow users to read books in different languages and/or listen to books in different languages. The memory cartridges that may store e-books, movies, and/or applications, etc in different language versions. This process of localization may be seen in FIG. 8B. Book 1 804 entitled “Lions, Tigers, and Bears” and stored in memory cartridge 28 may include various language versions of “Lions, Tigers, and Bears” in different languages. As seen in FIG. 8B, “Lions, Tigers, and Bears” may include three different language versions. One version in English, one version in Japanese, and one version in Spanish. It will be appreciated that there are other techniques for structuring the storage of content and/or localization information for memory devices that may be employed.

While the technology herein has been described in connection with exemplary illustrative non-limiting implementations, the invention is not to be limited by the disclosure. For example, while the exemplary illustrative non-limiting implementation references displaying an e-book, other types of content or application may also take advantage of the e-reader and its user interface. For example, games, pictures, movies, or other types of software applications or content may be loaded onto the e-reader. Other types of content may include specific types of applications and/or content targeted at specific user groups, such as, for example, police, military, fire, or medical personal. The invention is intended to be defined by the claims and to cover all corresponding and equivalent arrangements whether or not specifically disclosed herein.

We claim:

1. A handheld electronic reader (e-reader) comprising:
a first display surface and a second display surface, at least one of said first and second display surfaces having a touch panel associated therewith;
at least one memory device storing digital content; and
a processing arrangement operatively coupled to said first and second display surfaces and said memory device, said processing arrangement providing an interactive display of at least a portion of said stored digital content on said first and second display surfaces,
wherein said processing arrangement controls said first and second display surfaces to display substantially the same content in different languages.

2. The e-reader of claim 1 further including an audio transducer coupled to the processing arrangement, the audio transducer accepting voice commands.

3. The e-reader of claim 1 wherein said content includes text and said handheld e-reader further includes an audio transducer coupled to the processing arrangement, the audio transducer outputting sounds converted from said text.

4. The e-reader of claim 1 wherein said processing arrangement allows the user to access additional information by selecting portions of said content.

5. The e-reader of claim 4 wherein said processing arrangement allows said user to select portions of said content by pointing on said touch panel.

6. The e-reader of claim 1 further comprising a hinge arrangement connecting the first display surface to the second display surface.

7. The e-reader of claim 6, wherein the first and second display surfaces are structured to adopt a closed position such that a major surface area of the first display surface is substantially congruent with a major surface area of the second display surface.

8. A handheld electronic reader comprising:
a first display screen and a second display screen, at least one of said first and second display screens having a touch panel associated therewith;
at least one memory device storing digital content;
a processing arrangement operatively coupled to said first and second display screens and said memory device, said processing arrangement providing an interactive display of at least a portion of said stored digital content on said first and second display screens; and
an audio transducer coupled to the processing arrangement,
wherein said processing arrangement controls the audio transducer to output substantially the same content in a different language than as provided to the interactive display.

9. The e-reader of claim 8 further including an audio transducer coupled to the processing arrangement, the audio transducer accepting voice commands.

10. The e-reader of claim 8 wherein said content includes text and said handheld reader further includes an audio transducer coupled to the processing arrangement, the audio transducer outputting sounds converted from said text.

11. The e-reader of claim 8 wherein said processing arrangement allows the user to access additional information by selecting portions of said content.

12. The e-reader of claim 11 wherein said processing arrangement allows said user to select portions of said content by pointing on said touch panel.

13. The e-reader of claim 8, wherein the first and second display screens are structured such that in a closed position a major surface area of the first display screen is substantially congruent with a major surface area of the second display screen.

14. A non-transitory computer readable medium storing instructions for presenting digital content to a portable e-reader, the portable e-reader including a first display screen and a second display screen, a processing arrangement operatively coupled to said first and second display screens, an audio transducer coupled to the processing arrangement, the stored instructions comprising instructions configured to:
display a content on the first display screen in a first language;
display substantially similar content in a second language different from the first language on the second display, the substantially similar content related to the content displayed on the first display screen;
accept voice input through the audio transducer in the first language and the second language;
map the voice input to a plurality of commands; and
operate the portable e-reader through the plurality of commands.

16. The medium of claim 14 wherein the instructions are further configured to output through the audio transducer sounds related to the content in the first language or the second language.

17. The medium of claim 14 wherein the instructions are further configured to display additional information on the first or second display screen related to a selected portion of the content or substantially similar content.

18. The medium of claim 14 wherein a touch screen is coupled to the first or second display screen.
